(19) United States
(12) Patent Application Publication
(10) Pub. No.: US 2004/0257333 A1
(43) Pub. Date: Dec. 23, 2004

(54) Control system for image input device

(75) Inventor: Alex Chou, Taipei (TW)

Correspondence Address: BACON & THOMAS, PLLC, 625 SLATERS LANE, FOURTH FLOOR, ALEXANDRIA, VA, 22314

(73) Assignee: Axisoft Technologies Inc., Taipei County (TW)

(21) Appl. No.: 10/606,748

(22) Filed: Jun. 27, 2003

(30) Foreign Application Priority Data
Jun. 18, 2003 (TW) 092116517

(51) Int. Cl. G09G 5/00

(52) U.S. Cl. 345/156

(57) ABSTRACT

Control system for image input device comprises a control module, an electronic equipment selection module, an image specification setting module and an electronic equipment control signal decoder module. The control module functions to control the operation of hardware and related modules of the image input device. The electronic equipment selection module allows users to select electronic equipments to be connected with the image input device. The image specification setting module sets a group of factors relating to the specification of the input images. The electronic equipment control signal decoder module provides a decoder to convert control signals generated by the electronic equipment into control signals for the image input device and a firmware memory device to store decoding information useful in decoding control signals generated by the electronic equipment.

### FIELD OF THE INVENTION

The present invention relates to a control system for image input device, especially to a control system for digital camera.

### BACKGROUND OF THE INVENTION

Image input device connectable to other electronic devices, especially digital camera connectable to handset for mobile phone (hereinafter referred to as “handset”), has been a popular product in the market. With this kind of image input device, it is possible to transmit digitized image data into the electronic device to be further processed. Take the handset-connectable digital camera (hereinafter referred to as “handset digital camera”) for example. When a digital camera is connected to a handset, the user may use the buttons of the digital camera or the buttons of the handset to control the digital camera, such that digital images taken by the digital camera may be input into the handset and displayed on the screen of the handset. The user may also edit or store the digital image in the handset for further display or transmission.

The handset digital camera may be classified into two groups. One is the so-called “embedded handset digital camera”, which is a digital camera embedded in a handset. An embedded digital camera is always designed for particular models of handset. Manufacturer of the digital camera has already been provided with information regarding communication protocol of the handset in the early stage in designing the digital camera. The control system of such embedded digital camera is designed according to the feature of the handset with the provided information. The other group is the “standalone” digital camera. In most standalone handset digital cameras, the control system is designed for particular models of handset, if an interface is provided to interconnect the digital camera and the handset. As a result, a standalone handset digital camera can only work with particular models of handset.

For users of the standalone digital camera, when they buy a new handset that is neither supported by the digital camera nor equipped with an embedded camera, the user has to buy a new digital camera that is provided with a control system allowing it to communicate with that new handset. For makers of handset digital camera, to design particular control systems for digital camera in corresponding to respective models of handset is also a waste and inconvenience.

It is thus necessary to provide a digital camera that is able to work with different models of handset, without the need to design particular digital cameras for respective models of handset.

It is also necessary to provide a control system for digital camera such that the digital camera may selectively communicate with a variety of handset without the need to change the hardware of the digital camera.

In addition, due to the rapid development in the functionality of the handset, digital cameras developed according to existing models of handset may not be able to communicate with newly developed handsets. It is thus necessary to provide a control system for digital camera allowing the digital camera to communicate with newly developed digital cameras without the need to change the specification of the digital camera.

### OBJECTIVES OF THE INVENTION

The objective of this invention is to provide a control system for image input device, such that the image input device may selectively communicate with electronic equipment of a variety of model.

Another objective of this invention is to provide a control system for digital camera, enabling the digital camera to selectively communicate with handsets of different models.

Another objective of this invention is to provide a control system for digital camera, allowing the digital camera to communicate with latterly developed handsets after minor changes to the control system is made.

### SUMMARY OF THE INVENTION

According to this invention, a control system for image input device is provided. The control system for image input device of this invention comprises a control module, an electronic equipment selection module, an image specification setting module and an electronic equipment control signal decoder module. The control module functions to control the operation of hardware and related modules of the image input device. The electronic equipment selection module allows users to select electronic equipments to be connected with the image input device. The image specification setting module sets a group of factors relating to the specification of the input images. The electronic equipment control signal decoder module provides a decoder to convert control signals generated by the electronic equipment into control signals for the image input device and a firmware memory device to store decoding information useful in decoding control signals generated by the electronic equipment. The control system for image input device of this invention enables the image input device to selectively communicate with a variety of electronic equipment and to add decoding information for electronic equipments into the control system.

These and other objectives and advantages of this invention may be clearly understood from the following drawings.

### BRIEF DESCRIPTION OF THE DRAWINGS

FIG. 1 illustrates the system diagram of a digital camera to be connected to a handset.

FIG. 2 shows the block diagram of the control system for image input device of this invention.

FIG. 3 shows the flowchart of the control system for image input device of this invention.

### DETAILED DESCRIPTION OF THE INVENTION

A detailed description of the control system for image input device of this invention will be given below by referring to the drawings. In the detailed specification, a control system for digital camera to be connected to a handset for mobile phone (hereinafter referred to as “handset”) will serve as example of the control system for image input device, for illustration purposes. It shall be understood that the present invention may be used in other image input devices to be connected to handset of other electronic equipments.

FIG. 1 illustrates the system diagram of a digital camera to be connected to a handset. As shown in this figure, the digital camera 10 is connected to and communicates with a handset 19 through a communication interface 18. The communication interface 18 is provided in the handset 19, the hardware design of the interface and the communication protocol used in the interface shall comply with the requirements made by maker of the handset. In most cases, the communication protocol used in the interface is a standard accepted by the industry, such as an RS232 standard.

The digital camera 10 comprises a central processing unit 11, which is usually a commercially available processor chip, to control the operation of the hardware and software modules of the digital camera 10. As a result, the central processing unit may use a computer program stored in the main memory 13 to control the digital camera 10, such that they collectively function as the control system of the digital camera 10.

Digital camera 10 may provide a displaying device 12 to display a user interface and/or images being captured by the digital camera 10. In general such a displaying device is a liquid crystal display. However, in most cases this displaying device is not necessary, since the displaying device of the handset may function as the displaying device of the digital camera after the digital camera is connected to the handset. The image input device of the digital camera is an image sensor 16. Image sensors suited in this invention include optical image sensor, electrostatic image sensor and other suited planar image sensors. Image signals as sensed by the image sensor 16 is temporarily stored in the image memory 17, after they are converted into digital image data in the format required by the digital camera 10 by an image data converter 15. The converted image data may be transmitted to the central processing unit 11 through the image data converter 15, to be processed. In order to accelerate the processing of the image data and other data, a flash memory 14 may also be provided to function as spare memory.

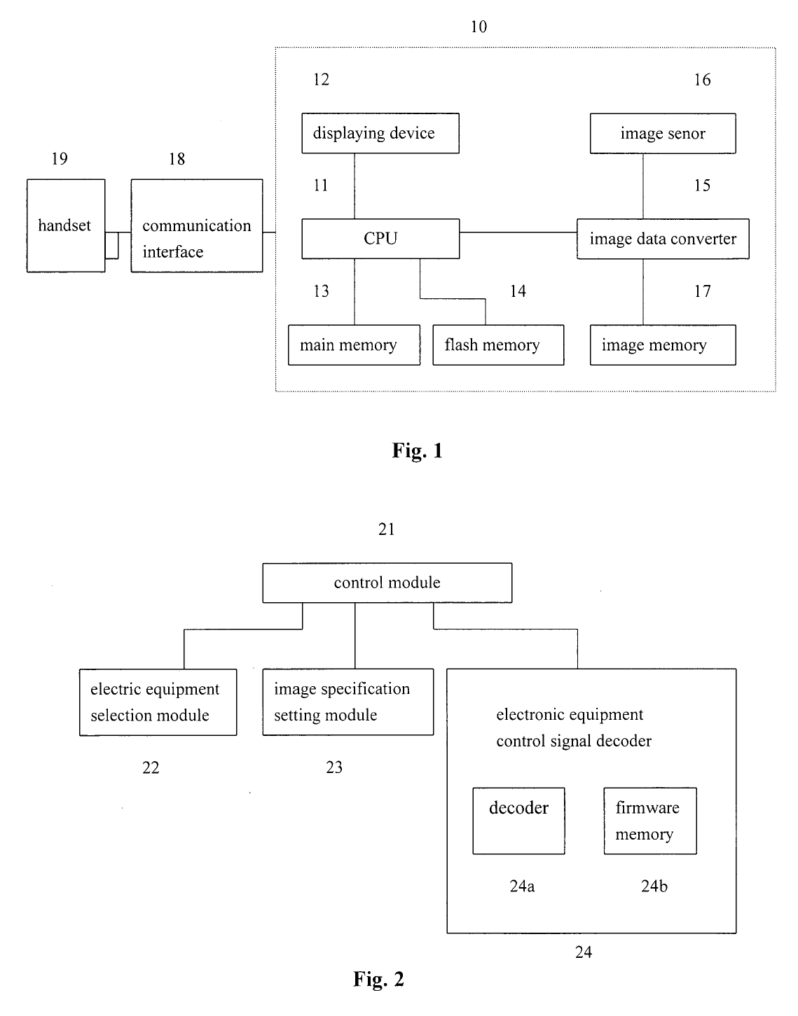

FIG. 2 shows the block diagram of the control system for image input device of this invention. As shown in this figure, the control system for image input device of this invention comprises a control module 21, an electronic equipment selection module 22, an image specification setting module 23 and an electronic equipment control signal decoder module 24. Among them:

The control module 21 functions to control the operation of hardware and related modules of the image input device 10. The electronic equipment selection module 22 allows users to select electronic equipments 19 to be connected with the image input device 10. The image specification setting module 23 sets a group of factors relating to the specification of the input images. The electronic equipment control signal decoder module 24 provides a decoder 24a to convert control signals generated by the electronic equipment 19 into control signals for the image input device 10 and a firmware memory device 24b to store decoding information useful in decoding control signals generated by the electronic equipment.

A description of the control system for image input device of this invention will be given by taking a digital camera to be connected to handset as example of the image input device in the followings.

The control module 20 functions to control the communication between the digital camera 10 and the handset 19 and to control the operation of ht elements of the digital camera 10 and all the related modules 22, 23 and 24. For example, when the control system for the digital camera is initialized (to be described in details hereinafter), the control module 21 transmits related signals and data to the handset 19; when the handset generates a “grab image” signal, the control module 21 transmits the signal to the electronic equipment control signal decoder module 24 to be decoded and transmits operational signals so decoded to the image data converter 15, such that image data generated by the image sensor 16 may be grabbed. The control module 21 can also transmit factors of the handset, as stored in the electronic equipment selection module 22 and image specification factors as stored in the image specification setting module 23 to the image data converter 15, so that regulations for converting the image data may be decided.

The electronic equipment selection module 22 provides a list of electronic equipments that can be selectively connected to the digital camera 10 and a look-up-table of related control factors in corresponding to the connectable electronic equipments. The electronic equipment selection module 22 enables makers and users to select model of handset to be connected to the digital camera, when the digital camera is made or before the user uses the digital camera when it is connected to the selected handset. In general, the related factors are collected according to the different specification and interface of particular handsets, expressed by a look-up-table and stored in the electronic equipment selection module 22.

The functions of the image specification setting module 23 include setting specification of digital images to be accessed by the handset. Specification of the digital image data comprises size, initial position, resolution, color, number of gray level etc of images to be captured. However, in some embodiments of this invention, providing the size of the image may be sufficient to satisfy most functions.

The electronic equipment control signal decoder module 24 decodes control signals generated by the electronic equipments to be connected by the image input device. The electronic equipment control signal decoder module 24 provides a decoder 24a to convert control signals generated by the electronic equipment into signals operable by the image input device 10. Such a decoder 24a may be a hardware circuit or a look-up-table. In some embodiments of this invention, a firmware memory device 24b may be provided and decoding formulas or decoding factors applicable to particular model(s) of electronic equipment may be affixed to the firmware memory 24b right after the image input device 10 is made. As a result, the image input device 10 can only work with the particular model of electronic equipment. The decoder module 2b may also provide a memory (not shown), such that, when control factors applicable to electronic equipments not listed in the electronic equipment selection module 22 may be added into the memory, such that the image input device 10 may work with new electronic equipments.

After model of electronic equipment to be connected is selected, specification of image to be grabbed is decided and the image input device is connected to the electronic equipment, the control system for image input device of this invention may operate all kinds of hardware and software controls in response to control signals generated by the electronic equipment, whereby digital images being grabbed may be transmitted to the electronic equipment.

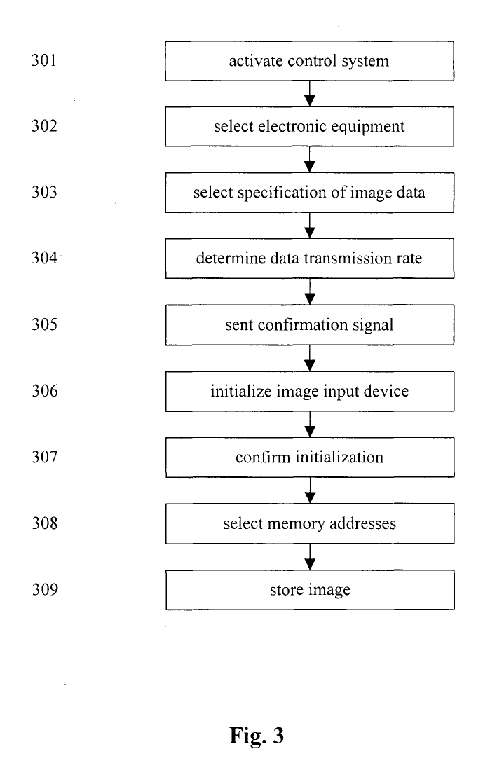

FIG. 3 shows the flowchart of the control system for image input device of this invention. In the followings a description of the operation of the system for image input device of this invention will be given, by taking the digital camera to be connected to handset as example of the image input device.

As shown in FIG. 3, at 301 the control system for image input device is activated. At 302 the electronic equipment to which the image input device will connect is selected. In this step, a preferable way is to display a list of model names of connectable electronic equipment on the displaying screen of either the image input device 10 or the electronic equipment 19, such that the user may select a model by pushing related buttons. If the model to be connected is not available in the list, an “others” item may be provided such that the user may fill into the user interface related factors, including model name of handset, applicable specifications and instructions. At 303, specification of image data to be grabbed and transmitted is selected. As described above, specification of the image data may include size of image and other useful factors. At 304 the data transmission rate between the image input device 10 and the electronic equipment 19 is determined. At 305 a confirmation signal is sent to the electronic equipment 19, whereby the response of the electronic equipment 19 is obtained. Thereafter, at 306 the initialization of the image input device 10 is conducted. The initialization comprises setting the image input device 10 according to factors obtained in the previous steps. At 307 a signal confirming the initialization of the image input device 10 and other related data are sent to the electronic equipment 19. At 308 addresses in the memory device of the electronic equipment 19 to store factors relating to the image input device 10 are selected and the related data are stored in the selected addresses at 309. The operation of the control system for image input device is thus completed. Thereafter, the image input device 10 may conduct all kinds of operation in response to instructions generated by the electronic equipment 19.

As described above, the control system for image input device of this invention is able to allow image input device to selectively communicate with a variety of electronic equipments and allows the user to add new models of electronic equipment to communicate with the image input device. As a result, either the maker or the user is allowed to select electronic equipments to be connected with the image input device.

As the present invention has been shown and described with reference to preferred embodiments thereof, those skilled in the art will recognize that the above and other changes may be made therein without departing from the spirit and scope of the invention.

What is claimed is:

1. Control system for image input device, enabling an image input device to operate in connection with an electronic device, comprising:
a control module to control the operation of hardware and related modules of said image input device;
an electronic equipment selection module allowing users to select electronic equipments to be connected with said image input device;
an image specification setting module to set a group of factors relating to the specification of images to be input; and
an electronic equipment control signal decoder module to provide a decoder to convert control signals generated by said electronic equipment into control signals operable by said image input device and a firmware memory device to store decoding information useful in decoding control signals generated by said electronic equipment;
characterized in that said control system for image input device enables said image input device to selectively communicate with a variety of electronic equipments.

2. The control system for image input device according to claim 1 wherein said image input device is digital camera and said electronic device is handset for mobile phone.

3. The control system for image input device according to claim 1 or 2, further comprising a memory to allow user to input and to store decoding information of control signals from electronic devices which decoding information is not stored in said firmware memory device.

4. The control system for image input device according to claim 1 or 2, wherein factors as set in said image specification setting module comprise at least one of size, initial position, resolution, color and number of gray level of images to be captured.
